(19) United States
(12) Patent Application Publication
(10) Pub. No.: US 2023/0194972 A1
(43) Pub. Date: Jun. 22, 2023

(54) LIGHT HOMOGENIZING ELEMENT AND PROJECTION DEVICE

(71) Applicant: Coretronic Corporation, Hsin-Chu (TW)

(72) Inventors: Ming-Tsung Weng, Hsin-Chu (TW); Chun-Ju Wang, Hsin-Chu (TW); Chang-Hsuan Chen, Hsin-Chu (TW)

(73) Assignee: Coretronic Corporation, Hsin-Chu (TW)

(21) Appl. No.: 18/080,741

(22) Filed: Dec. 14, 2022

(30) Foreign Application Priority Data
Dec. 16, 2021 (CN) 202123164955.5

(51) Int. Cl. G03B 21/20

(52) U.S. Cl. CPC G03B 21/208; G03B 21/2006

(57) ABSTRACT

A light homogenizing element comprising a light incident surface, a light-emitting surface and a plurality of side surfaces is provided. The plurality of side surfaces are connected between the light incident surface and the light-emitting surface, the light-emitting surface is not parallel to the light incident surface, and the light-emitting surface includes a first side and a second side opposite to the first side, and the first side is not parallel to the second side. A projection device using the light homogenizing element is also provided.

### CROSS-REFERENCE TO RELATED APPLICATION

This application claims the priority benefit of China application serial no. 202123164955.5 filed on Dec. 16, 2021. The entirety of the above-mentioned patent application is hereby incorporated by reference herein and made a part of this specification.

### BACKGROUND

### Technical Field

The invention relates to an optical element and an optical device, and particularly relates to a light homogenizing element and a projection device.

### Description of Related Art

In a projection device, a light homogenizing element may be disposed between a light source module and a light valve to improve uniformity of an illumination beam. However, in the existing projection devices, the light homogenizing element is disposed obliquely relative to the light valve. After a light beam is emitted from the light homogenizing element and transmitted to the light valve, a portion of a light spot formed by the light beam on a portion of the light valve that is farther away from or closer to the light homogenizing element will not be focused sharply due to the optical path difference. Namely, the light beam emitted from the light homogenizing element cannot form a light spot on the light valve that is sharply focused in all portions at the same time. Particularly, the portion of the light spot at a position far from the light homogenizing element is not well focused. In order to solve the above problems, there is an urgent need to develop a light homogenizing element capable of forming a light spot on the light valve that is sharply focused in various portions at the same time, so as to improve an image sharpness of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a light homogenizing element and a projection device, where all portions of a light spot formed on a light valve by a light beam transmitted to the light valve after penetrating through the light homogenizing element are adapted to be sharply focused at the same time, and the projection device using the light homogenizing element has good image sharpness.

Other objects and advantages of the invention may be further illustrated by the technical features broadly embodied and described as follows.

In order to achieve one or a portion of or all of the objects or other objects, an embodiment of the invention provides a light homogenizing element comprising a light incident surface, a light-emitting surface and a plurality of side surfaces, the plurality of side surfaces are connected between the light incident surface and the light-emitting surface, the light-emitting surface is not parallel to the light incident surface, and the light-emitting surface includes a first side and a second side opposite to the first side, and the first side is not parallel to the second side.

According to an embodiment of the invention, the light-emitting surface further includes a third side and a fourth side, the third side connects an end of the first side and an end of the second side, and the fourth side connects the other end of the first side and the other end of the second side, the third side is opposite to the fourth side, and the third side is not parallel to the fourth side.

According to an embodiment of the invention, lengths of the first side, the second side, the third side, and the fourth side are different.

According to an embodiment of the invention, included angles between two adjacent ones of the first side, the second side, the third side and the fourth side are not equal to 90 degrees.

According to an embodiment of the invention, the first side, the second side, the third side and the fourth side intersect with each other at a plurality of endpoints of the light-emitting surface, and vertical projection positions of the plurality of endpoints on a central axis of the light homogenizing element are different, and the central axis is parallel to a normal line of the light incident surface.

According to an embodiment of the invention, the first side, the second side, the third side, and the fourth side are not located on a same plane.

According to an embodiment of the invention, the light-emitting surface is non-planar.

According to an embodiment of the invention, the light incident surface includes a third side and a fourth side, the third side of the light incident surface is opposite to the first side of the light-emitting surface, the fourth side of the light incident surface is opposite to the second side of the light-emitting surface, the third side of the light incident surface is not parallel to the first side of the light-emitting surface, and the fourth side of the light incident surface is not parallel to the second side of the light-emitting surface.

According to an embodiment of the invention, the light homogenizing element is a quadrangular column, and lengths of a plurality of sides of at least one of the side surfaces are different from each other.

According to an embodiment of the invention, the light homogenizing element is a solid column or a hollow column.

According to an embodiment of the invention, the light-emitting surface further includes a third side and a fourth side, the third side connects an end of the first side and an end of the second side, the fourth side connects the other end of the first side and the other end of the second side, the third side is opposite to the fourth side, and the third side is parallel to the fourth side.

According to an embodiment of the invention, the first side, the second side, the third side, and the fourth side have different lengths.

According to an embodiment of the invention, vertical projection positions of a plurality of endpoints where the first side, the second side and the third side intersect with each other on a central axis of the light homogenizing element are the same, and vertical projection positions of a plurality of endpoints where the first side, the second side and the fourth side intersect with each other on the central axis are the same, the vertical projection positions of the endpoints where the first side, the second side and the third side intersect with each other on the central axis are different to the vertical projection positions of the endpoints where the first side, the second side and the fourth side intersect with each other on the central axis, and the central axis is parallel to a normal line of the light incident surface.

According to an embodiment of the invention, included angles between two adjacent ones of the first side, the second side, the third side and the fourth side are not equal to 90 degrees.

An embodiment of the invention provides a projection device including a light source module, a light homogenizing element, a light valve and a projection lens. The light source module is configured to provide an illumination beam. The light homogenizing element is disposed on a transmission path of the illumination beam. The light homogenizing element includes a light incident surface, a light-emitting surface and a plurality of side surfaces. The plurality of side surfaces are connected between the light incident surface and the light-emitting surface. The light-emitting surface is not parallel to the light incident surface, the light-emitting surface includes a first side and a second side opposite to the first side, and the first side is not parallel to the second side. The light valve is disposed on the transmission path of the illumination beam, and is configured to convert the illumination beam coming from the light homogenizing element into an image beam. The projection lens is disposed on a transmission path of the image beam, and is configured to project the image beam out of the projection device.

Based on the above description, in the light homogenizing element provided by the embodiment of the invention, the light-emitting surface and the light incident surface that are not parallel to each other, and at least a pair of opposite sides of the light-emitting surface are configured to be unparallel to each other, so that at least two of the different endpoints of the light-emitting surface have different vertical projection positions on the central axis of the light homogenizing element. Compared with the prior art in which the opposite sides of the light-emitting surface are all designed to be parallel to each other, the light-emitting surface of the light homogenizing element provided by the embodiment of the invention has higher flexibility in design, so that the light beam emitted from the light-emitting surface may form a light spot on the light valve that is sharply focused in all portions at the same time. The projection device provided by another embodiment of the invention adopts the above-mentioned light homogenizing element to provide good image sharpness.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic three-dimensional view of a light homogenizing element according to an embodiment of the invention.

FIG. 1B is a schematic diagram of a light-emitting surface of the light homogenizing element shown in FIG. 1A.

FIG. 2 is a schematic diagram of a light-emitting surface of a light homogenizing element according to an embodiment of the invention.

FIG. 3A is a schematic three-dimensional view of a light homogenizing element according to an embodiment of the invention.

FIG. 3B is a top view of the light homogenizing element shown in FIG. 3A.

FIG. 3C is a side view of the light homogenizing element shown in FIG. 3A.

FIG. 4 is a schematic diagram of a projection device according to an embodiment of the invention.

FIG. 5A is a schematic diagram of partial portions of a light spot on a light valve of a projection device according to a comparative example.

FIG. 5B is a schematic diagram of partial portions of a light spot on a light valve of a projection device according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “left,” “right,” “front,” “back,” etc., is used with reference to the orientation of the Figure(s) being described and are not intended to be limiting of the invention.

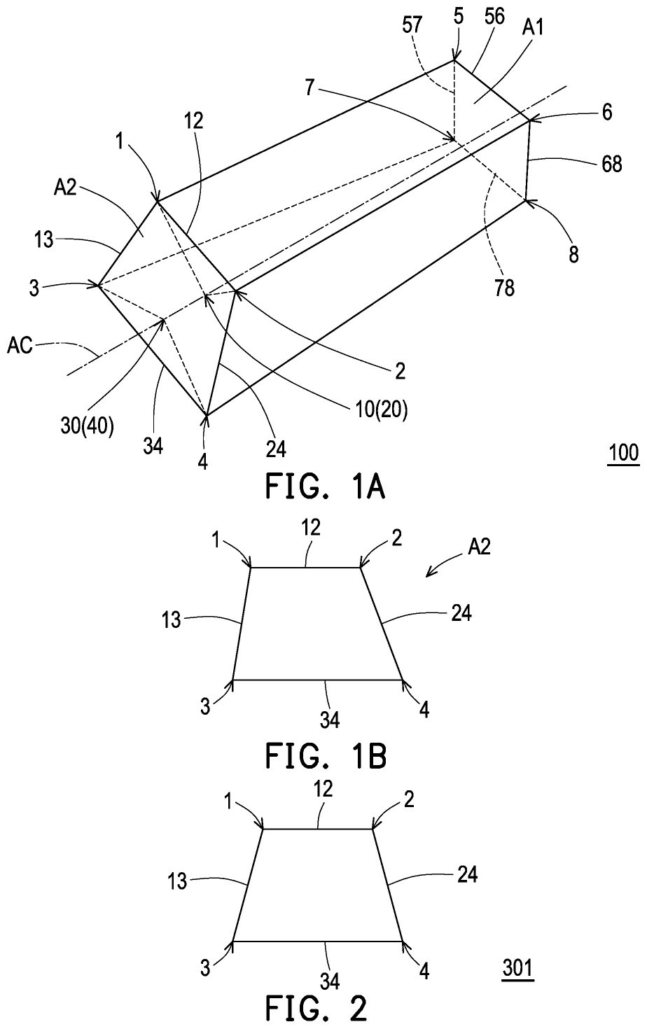

Referring to FIG. 1A to FIG. 1B, FIG. 1A is a schematic three-dimensional view of a light homogenizing element according to an embodiment of the invention. FIG. 1B is a schematic diagram of a light-emitting surface of the light homogenizing element shown in FIG. 1A.

In the embodiment, the light homogenizing element 100 is a quadrangular column, but the invention is not limited thereto, and the light homogenizing element 100 may be a polygonal column different from the quadrangular column. The light homogenizing element 100 includes a light incident surface A1, a light-emitting surface A2, and a plurality of side surfaces connected between the light incident surface A1 and the light-emitting surface A2, and the light-emitting surface A2 is not parallel to the light incident surface A1. In the embodiment, the light-emitting surface A2 is inclined relative to the light incident surface A1, where the light-emitting surface A2 includes a first side 13, a second side 24 opposite to the first side 13, a third side 12 and a fourth side 34 opposite to the third side 12, where the first side 13 is not parallel to the second side 24. In the embodiment, the third side 12 is parallel to the fourth side 34, the third side 12 connects an endpoint 1 at one end of the first side 13 and an endpoint 2 at one end of the second side 24, and the fourth side 34 connects an endpoint 3 at the other end of the first side 13 and an endpoint 4 at the other end of the second side 24, and an outline shape of the light-emitting surface A2 constructed by the above sides and endpoints is trapezoid.

Referring to FIG. 1A and FIG. 1B, in an embodiment, lengths of the first side 13, the second side 24, the third side 12 and the fourth side 34 of the light-emitting surface A2 are different, and included angles between two adjacent ones of the first side 13, the second side 24, the third side 12 and the fourth side 34 are not equal to 90 degrees. However, the invention is not limited thereto. In other embodiments, one of the first side 13 and the second side 24 may have a same length as any one of the third side 12 and the fourth side 34, as shown in FIG. 2.

In the embodiment, the light-emitting surface A2 is inclined relative to the light incident surface A1, and the third side 12 is the closest to the light incident surface A1 among the first side 13, the second side 24, the third side 12 and the fourth side 34. A vertical projection of the endpoint 1 on a central axis AC of the light homogenizing element 100 is a point 10, where the central axis AC is parallel to a normal line of the light incident surface A1, a vertical projection of the endpoint 2 on the central axis AC of the light homogenizing element 200 is a point 20, and the point 10 and the point 20 have a same position on the central axis AC, and overlap with each other. The fourth side 34 is the farthest to the light incident surface A1 among the first side 13, the second side 24, the third side 12 and the fourth side 34, where a vertical projection of the endpoint 3 on the central axis AC of the light homogenizing element 100 is a point 30, a vertical projection of the endpoint 4 on the central axis AC of the light homogenizing element 200 is a point 40, and the point 30 and the point 40 have a same position on the central axis AC, which does not overlap with the positions of the points 10 and 20 on the central axis AC. According to the above description, it is known that in the embodiment, at least two of the endpoints on the light-emitting surface A2 have different vertical projection positions on the central axis AC of the light homogenizing element 100. Therefore, the light beams emitted from the endpoints of the light-emitting surface A2 may have at least two optical paths with different distances, and when the light homogenizing element is set obliquely relative to the light valve, the light homogenizing element may be used to make up for the situation that it is unable to focus sharply due to the optical path difference. Moreover, since the light homogenizing element is set obliquely relative to the light valve, and hence a light beam is incident obliquely to the light valve from the light-emitting surface of the light homogenizing element, the light spot on the light valve may usually be deformed. For example, if the light-emitting surface of the light homogenizing element is rectangular, the light spot of the light beam on the light valve may be deformed into a trapezoid. Therefore, in the embodiment, by making an outline shape of the light-emitting surface A2 of the light homogenizing element 100 to be trapezoid, the light spot deformation caused by the oblique incidence may be appropriately adjusted back to rectangular. Through the above structure, the light-emitting surface A2 has high flexibility in design, and is not limited to the rectangular shape, so that the light beam emitted from the light-emitting surface A2 may be preferably focused on the light valve.

The light homogenizing element provided by the embodiment of the invention may be a solid column or a hollow column, and is not limited to a rectangular solid column or a rectangular hollow column, where the light-emitting surface thereof may have five sides or more, or have curved sides. Since the light homogenizing element provided by the embodiment of the invention has high flexibility in design, the light beam emitted from the light-emitting surface A2 may preferably form the light spot that is sharply focused in all portions on other optical elements at the same time.

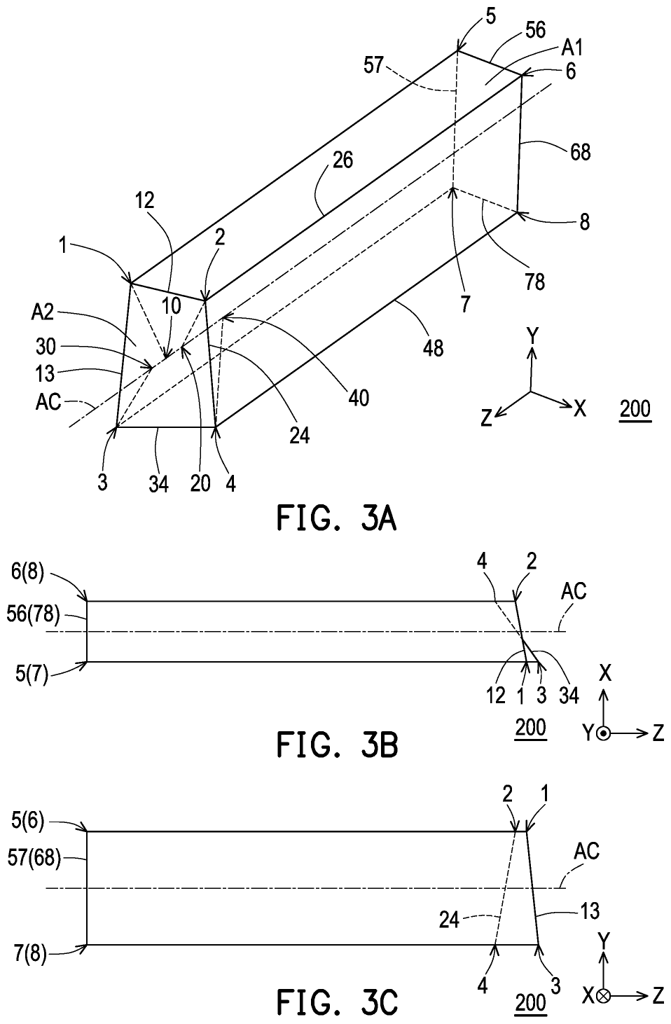

Referring to FIG. 3A to FIG. 3C, FIG. 3A is a schematic three-dimensional view of a light homogenizing element according to an embodiment of the invention. FIG. 3B is a top view of the light homogenizing element shown in FIG. 3A. FIG. 3C is a side view of the light homogenizing element shown in FIG. 3A.

In the embodiment, a light homogenizing element 200 includes a light incident surface A1, a light-emitting surface A2 and a plurality of side surfaces connected between the light incident surface A1 and the light-emitting surface A2, and the light-emitting surface A2 is not parallel to the light incident surface A1. The light homogenizing element 200 is similar to the light homogenizing element 100 in FIG. 1A-1B, and the similarities will not be repeated, while a difference there between is that the third side 12 of the light-emitting surface A2 of the light homogenizing element 200 is not parallel to the fourth side 34.

In the embodiment, there is no segment difference between every two adjacent ones of the first side 13, the second side 24, the third side 12 and the fourth side 34, and the included angles between the two adjacent ones of the first side 13, the second side 24, the third side 12 and the fourth side 34 are not equal to 90 degrees.

A vertical projection of the endpoint 1 on the central axis AC of the light homogenizing element 200 is a point 10, a vertical projection of the endpoint 2 on the central axis AC of the light homogenizing element 100 is a point 20, a vertical projection of the endpoint 3 on the central axis AC of the light homogenizing element 200 is a point 30, and a vertical projection of the endpoint 4 on the central axis AC of the light homogenizing element 100 is a point 40. As shown in FIG. 3A, the point 10, the point 20, the point 30 and the point 40 respectively locate on different positions of the central axis AC, and do not overlap with each other. In other words, the light-emitting surface A2 is not a plane, and the first side 13, the second side 24, the third side 12 and the fourth side 34 are not located on a same plane, so that the light-emitting surface A2 is not parallel to the light incident surface A1.

Referring to FIG. 3A, the light incident surface A1 is rectangular and includes a side 57, a side 68, a side 56 and a side 78, where the side 57 is parallel to side 68, and the side 56 is parallel to the side 78. Taking a side surface formed by intersecting the second side 24 of the light-emitting surface A2, the side 68, a side 26 and a side 48 as an example, the lengths of the side 26 and the side 48 are different from each other, and the side 68 of the light incident surface A1 is not parallel to the second side 24 of the light-emitting surface A2. Referring to FIG. 3A, it may be seen that lengths of the four sides of the side surface formed by intersecting the second side 24, the side 68, the side 26 and the side 48 are different from each other.

Referring to FIG. 3A, FIG. 3B and FIG. 3C, the side 56 and the side 78 of the light incident surface A1 are respectively opposite to the third side 12 and the fourth side 34 of the light-emitting surface A2, and the side 56 and the side 78 of the light incident surface A1 are respectively not parallel to the third side 12 and the fourth side 34 of the light-emitting surface A2, where the endpoint 2 is closer to the light incident surface A1 than the endpoint 1, the endpoint 2 is farther away from the light incident surface A1 than the endpoint 4, the endpoint 3 is farther away from the light incident surface A1 than the endpoint 1, and the endpoint 3 is farther away from the light incident surface A1 than the endpoint 4. Similarly, the sides 57 and 68 of the light incident surface A1 are respectively opposite to the first side 13 and the second side 24 of the light-emitting surface A2, and the sides 57 and 68 of the light incident surface A1 are respectively not parallel to the first side 13 and the second side 24 of the light-emitting surface A2, and the side 57 of the light incident surface A1 is not parallel to the first side 13 of the light-emitting surface A2.

According to FIGS. 3A-3C, it is known that in the embodiment, the first side 13 of the light-emitting surface A2 of the light homogenizing element 200 is not parallel to the second side 24 , and the third side 12 is not parallel to the fourth side 34, so that the endpoints on the light-emitting surface A2 have different vertical projection positions on the central axis AC of the light homogenizing element 200. Therefore, the light beams emitted from the endpoints of the light-emitting surface A2 may have optical paths with different distances, and when the light homogenizing element is set obliquely relative to the light valve, the light homogenizing element may be used to make up for the situation that it is unable to focus sharply due to the optical path difference. Generally, since each endpoint is a portion of the light-emitting surface A2 that is the farthest from the central axis AC of the light homogenizing element 200, and usually corresponds to the part of the light spot that cannot be sharply focused, through the description of the above structure, the light-emitting surface A2 has higher flexibility in design, and the outline shape of the light-emitting surface A2 may be adjusted according to the part of the light spot that cannot be sharply focused, so that the light beam emitted from the light-emitting surface A2 can be preferably focused on the light valve.

It should be noticed that reference numbers of the components and a part of contents of the aforementioned embodiment are also used in the following embodiment, wherein the same reference numbers denote the same or like components, and descriptions of the same technical contents are omitted. The aforementioned embodiment may be referred for descriptions of the omitted parts, and detailed descriptions thereof are not repeated in the following embodiment.

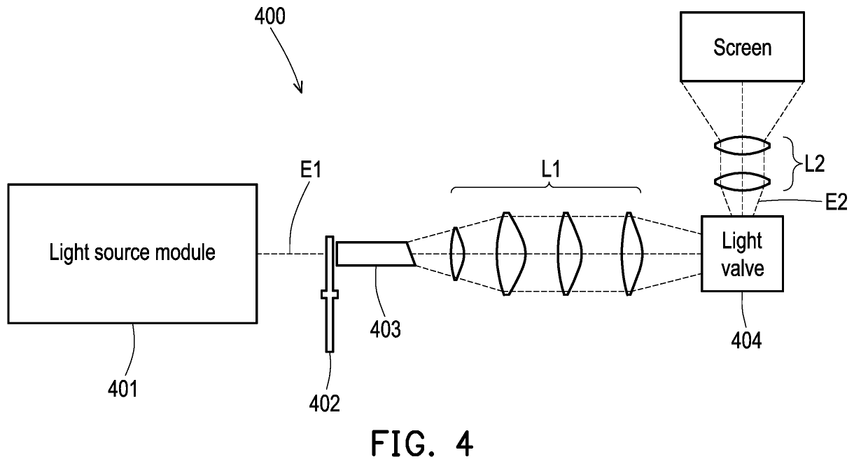

Referring to FIG. 4, FIG. 4 is a schematic diagram of a projection device according to an embodiment of the invention. A projection device 400 includes a light source module 401, a color wheel 402, a light homogenizing element 403, a lens set L1, a light valve 404, and a projection lens L2. The light source module 401 is configured to provide an illumination beam E1. The color wheel 402 performs color separation to the illumination beam E1. The light homogenizing element 403 is disposed on a transmission path of the illumination beam E1, and the light homogenizing element 403 may be implemented by any light homogenizing element in the above-mentioned embodiments or by at least one of the above-mentioned light homogenizing elements. The light valve 404 is disposed on the transmission path of the illumination beam E1, and is configured to convert the illumination beam E1 coming from the light homogenizing element 403 into an image beam E2. The lens set L1 is arranged between the light homogenizing element 403 and the light valve 404 to optimize a focusing condition of a light spot on the light valve 404. The projection lens L2 is disposed on a transmission path of the image beam E2, and is configured to project the image beam E2 out of the projection device 400, for example, onto a screen.

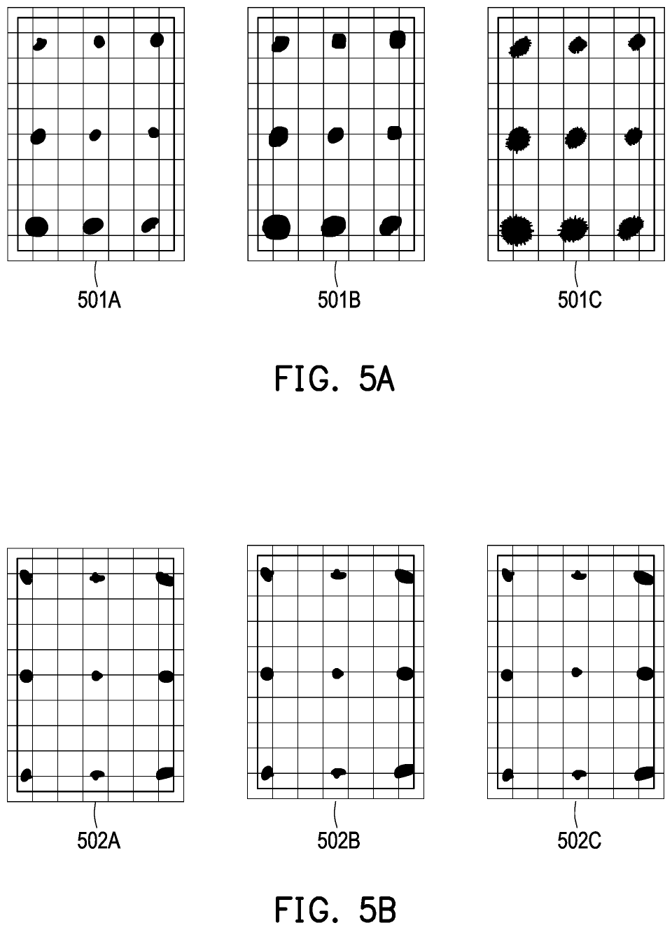

Referring to FIG. 5A and FIG. 5B, FIG. 5A is a schematic diagram of partial portions of a light spot on a light valve of a projection device according to a comparative example. FIG. 5B is a schematic diagram of partial portions of a light spot on the light valve 404 of the projection device 400 shown in FIG. 4. Where, 501A, 501B, and 501C are respectively light spot block diagrams of partial portions of light spots formed on the light valve 404 by light beams emitted from 9 positions of the light-emitting surface of the light homogenizing element of the comparative example by simulating a red light beam, a green light beam and a blue light beam, and 502A, 502B, and 502C are respectively light spot block diagrams of partial portions of light spots formed on the light valve 404 by light beams emitted from 9 positions of the light-emitting surface of the light homogenizing element of an embodiment of the invention by simulating a red light beam, a green light beam and a blue light beam. It should be noted that the light beam emitted from the light-emitting surface of the light homogenizing element and irradiated on the light valve generally forms a single light spot covering the whole light valve. However, in order to specifically explain a focus variation of each portion of the light spot, it is simulated that the light emitted from different positions on the light-emitting surface of the light homogenizing element corresponds to different portions of the light spot on the light valve. In FIG. 5A, it may be clearly seen that different portions of the light spot have light spot blocks of different sizes due to different focusing degrees, where the bigger the light spot is, the less possibility it is sharply focused at this position, and in the simulation, since the light homogenizing element is obliquely set relative to the light valve, it may be seen that the phenomenon of unable to implement sharp focusing on the side relatively far away from the light homogenizing element is more serious. The light spot block diagrams 502A, 502B, and 502C of FIG. 5B are obtained after the light homogenizing element of the invention is used, compared with the light spot block diagrams 501A, 501B, and 501C of the comparative example, the size of each portion of the light spot is smaller and more consistent. Therefore, different portions of the light spot on the light valve 404 may have good focusing conditions at the same time, and the projection device 400 may provide good image sharpness.

In summary, in the light homogenizing element provided by the embodiment of the invention, at least a pair of the opposite sides of the light-emitting surface are configured to be not parallel to each other, and the light-emitting surface is not parallel to the light incident surface, such that at least two of the different endpoints of the light-emitting surface have different vertical projection positions on the central axis of the light homogenizing element. Compared with the prior art in which the opposite sides of the light-emitting surface are all designed to be parallel to each other, every light-emitting surface of the light homogenizing elements provided by the embodiments of the invention has higher flexibility in design, so that the light beam emitted from the light-emitting surface may form a light spot on the light valve that is sharply focused in all portions at the same time. The projection device provided by another embodiment of the invention adopts one of the above-mentioned light homogenizing elements to provide good image sharpness.

It will be apparent to those skilled in the art that various modifications and variations of the disclosed embodiments can be made without departing from the scope or spirit of the invention. In view of the foregoing, it is intended that this disclosure cover modifications and variations that fall within the scope of the appended claims and their equivalents.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light homogenizing element, comprising:
a light incident surface;
a light-emitting surface; and
a plurality of side surfaces, connected between the light incident surface and the light-emitting surface, wherein the light-emitting surface is not parallel to the light incident surface, the light-emitting surface comprises a first side and a second side opposite to the first side, and the first side is not parallel to the second side.

2. The light homogenizing element as claimed in claim 1, wherein the light-emitting surface further comprises a third side and a fourth side, the third side connects an end of the first side and an end of the second side, and the fourth side connects the other end of the first side and the other end of the second side, the third side is opposite to the fourth side, and the third side is not parallel to the fourth side.

3. The light homogenizing element as claimed in claim 2, wherein lengths of the first side, the second side, the third side, and the fourth side are different.

4. The light homogenizing element as claimed in claim 2, wherein included angles between two adjacent ones of the first side, the second side, the third side and the fourth side are not equal to 90 degrees.

5. The light homogenizing element as claimed in claim 2, wherein the first side, the second side, the third side and the fourth side intersect with each other at a plurality of endpoints of the light-emitting surface, vertical projection positions of the plurality of endpoints on a central axis of the light homogenizing element are different, and the central axis is parallel to a normal line of the light incident surface.

6. The light homogenizing element as claimed in claim 2, wherein the first side, the second side, the third side, and the fourth side are not located on a same plane.

7. The light homogenizing element as claimed in claim 6, wherein the light-emitting surface is non-planar.

8. The light homogenizing element as claimed in claim 1, wherein the light incident surface comprises a third side and a fourth side, the third side is opposite to the first side, the fourth side is opposite to the second side, the third side is not parallel to the first side, and the fourth side is not parallel to the second side.

9. The light homogenizing element as claimed in claim 1, wherein the light homogenizing element is a quadrangular column, and lengths of a plurality of sides of at least one of the side surfaces are different from each other.

10. The light homogenizing element as claimed in claim 1, wherein the light homogenizing element is a solid column or a hollow column.

11. The light homogenizing element as claimed in claim 1, wherein the light-emitting surface further comprises a third side and a fourth side, the third side connects an end of the first side and an end of the second side, the fourth side connects the other end of the first side and the other end of the second side, the third side is opposite to the fourth side, and the third side is parallel to the fourth side.

12. The light homogenizing element as claimed in claim 11, wherein lengths of the first side, the second side, the third side, and the fourth side are different from each other.

13. The light homogenizing element as claimed in claim 11, wherein vertical projection positions of a plurality of endpoints where the first side, the second side and the third side intersect with each other on a central axis of the light homogenizing element are the same, and vertical projection positions of a plurality of endpoints where the first side, the second side and the fourth side intersect with each other on the central axis are the same, the vertical projection positions of the endpoints where the first side, the second side and the third side intersect with each other on the central axis are different to the vertical projection positions of the endpoints where the first side, the second side and the fourth side intersect with each other on the central axis, and the central axis is parallel to a normal line of the light incident surface.

14. The light homogenizing element as claimed in claim 11, wherein included angles between two adjacent ones of the first side, the second side, the third side and the fourth side are not equal to 90 degrees.

15. A projection device, comprising a light source module, a light homogenizing element, a light valve and a projection lens, wherein:
the light source module is configured to provide an illumination beam,
the light homogenizing element is disposed on a transmission path of the illumination beam, the light homogenizing element comprises a light incident surface, a light-emitting surface and a plurality of side surfaces, the plurality of side surfaces are connected between the light incident surface and the light-emitting surface, the light-emitting surface is not parallel to the light incident surface, the light-emitting surface comprises a first side and a second side opposite to the first side, and the first side is not parallel to the second side,
the light valve is disposed on the transmission path of the illumination beam, and is configured to convert the illumination beam coming from the light homogenizing element into an image beam,
the projection lens is disposed on a transmission path of the image beam, and is configured to project the image beam out of the projection device.
